(19) United States
(12) Patent Application Publication
(10) Pub. No.: US 2011/0008620 A1
(43) Pub. Date: Jan. 13, 2011

(54) Fiber with 4T cross section

(75) Inventor: Kuo-Chung Wu, Taoyuan County (TW)

Correspondence Address: BACON & THOMAS, PLLC, 625 SLATERS LANE, FOURTH FLOOR, ALEXANDRIA, VA, 22314-1176, US

(73) Assignee: Shinkong Synthetic Fibers Corporation, Taipei (TW)

(21) Appl. No.: 12/585,986

(22) Filed: Sep. 30, 2009

(30) Foreign Application Priority Data
Jul. 7, 2009 (TW) 098122940

(51) Int. Cl. D02G 3/22; D01D 5/253; B29C 47/00

(52) U.S. Cl. 428/397; 425/76; 264/177.13

(57) ABSTRACT

The present invention relates to a fiber with 4T cross section, comprising four T-shaped lobes, each of said T-shaped lobes having a cap portion and a leg portion, the leg portion of each of said lobes intersecting at the center of the fiber, each of said lobes separating from each other, and the adjacent T-shaped lobes forming an open hollow portion. Moreover, parameters such as Denier, opening range of the hollow portion, hollowness ratio, and degree of variation of the cross section are specifically defined. The fiber of this invention has guide channels design and thus can preserve relatively large clearances. Accordingly, the fabrics woven by the fiber of this invention have the outstanding capabilities of absorbing moisture and relieving sweat and the effect of keeping warm without creating a muggy feeling.

### FIELD OF THE INVENTION

The present invention relates to a fiber, particularly, to a fiber with 4T cross section.

### BACKGROUND OF THE INVENTION

Fibers with different shapes of cross section, such as cross-shaped, Y-shaped, W-shaped, or circle-shaped cross section, are well known. These kinds of fibers normally have the function of absorbing moisture and relieving sweat.

U.S. Pat. No. 5,057,368 discloses a fiber with 3T or 4T cross section. Each of T-shaped lobes of the fiber has a specific relation between the length and width. The patent also discloses a spinneret for producing such fibers. As known by the applicant, the spinning operation using such spinneret is difficult and there is no commercialized process for the product. Moreover, the slit of spinning nozzle of the spinneret is easily worn out, causing the cross section of the fiber to deform.

Therefore, it is highly desired to have a fiber that can be easily produced and the produced fabrics have excellent function of absorbing moisture and relieving sweat.

### SUMMARY OF THE INVENTION

The present invention provides a fiber with 4T cross section and a spinneret for producing such fiber. The fiber with 4T cross section has guide channels and can preserves relatively large clearances between fibers. Fabrics woven by the fiber have the outstanding capability of absorbing moisture and relieving sweat and the effect of keeping warm without creating a muggy feeling.

In accordance with one aspect of the invention, a fiber with 4T cross section is provided. The fiber comprises four T-shaped lobes, each of which has a cap portion and a leg portion. Each of the leg portions intersect at the center of the fiber and each of lobes separates from each other. The adjacent T-shaped lobes form an open hollow portion.

The fiber with 4T cross section satisfies the following requirements:

0.8≦Denier≦20

10°≦θ≦60°

10%≦Hollowness Ratio≦30%

2≦Degree of Variation of the cross section(R/r)≦6

wherein
θ represents the range of the hollow portion,
R represents the radius of the circumcircle of the fiber, and
r represents the radius of the incircle of the fiber.

In the context, the circumcircle is a hypothetical circle circumscribing the outmost sides of cap portions of the T-shaped lobes of the fiber with 4T cross section.

In the context, the incircle is a hypothetical circle inscribing the connection portions of the leg portions of the T-shaped lobes of the fiber with 4T cross section.

In the context, Denier is obtained by the following CNS 13756 Test Method for fiber fineness:

Comb several fiber samples in parallel with a metal comb and place them on a cutting table. Press them with a plate gage while the samples are drawn straightly by proper tension. Cut the samples at the length of 30 mm. Count 300 short fibers to form one set of samples (if the fiber is shorter than 30 mm, just make the total length of the chosen fibers to be 9000 mm). Measure the mass of the set of samples so as to obtain the measure of fiber Denier (d′). Obtain the standard fiber Denier (d) by using equilibrium moisture regain from the following equation. Test five times and calculate the average to the first decimal place.

Standard fiber Denier

$$( d ) = {d}^{′} \times \frac{100 + Rc}{100 + Re}$$

wherein
d′ represents the measure of fiber Denier,
Rc represents the nominal moisture regain (%),
Re represents the equilibrium moisture regain (%).

In the context, the hollowness ratio is obtained by the following method: The cross section of a monofilament is magnified 400 times by using an optical microscope to measure the average ratio between the total areas of the hollow portions and the total areas of the cross sections for 20 monofilaments.

In the context, the degree of variation of the cross section is obtained by the following method: The cross section of a monofilament is magnified 400 times to measure the radius of the circumcircle of the fiber (R) and the radius of the incircle of the fiber (r). Then the degree of variation of the cross section is calculated according to the following equation:

Degree of Variation of the cross section=R/r

Unlike the tight stack of conventional fibers, the fiber that satisfies the above requirements can preserve relatively large clearances. Fabrics woven by this fiber have outstanding capability of absorbing moisture and relieving sweat and the effect of keeping warm without creating a muggy feeling.

The opening range of the hollow portion of the 4T cross section fiber of the present invention is about 10° to about 60°, and the hollowness ratio is about 10% to about 30%, thereby obtaining excellent effects of moisture absorption and sweat release.

Preferably, the opening range of the hollow portion of the 4T cross section fiber of the present invention is about 15° to about 45°. If the opening range of the hollow portion is smaller than 10°, the clearances between the T-shaped lobes are easily closed during the spinning process, therefore reducing the effect of moisture absorption and sweat release. If the opening range of the hollow portion is greater than 60°, the fibers will stack too tightly. This also reduces the effect of moisture absorption and sweat release.

The 4T cross section fiber of the present invention includes four T-shaped lobes and four open hollow portions. The hollowness ratio is about 10% to about 30%, preferably, about 15% to about 25%. If the hollowness ratio is below 10%, this implies that the open hollow portions are not properly formed and will thus reduce the effect of moisture absorption and sweat release. If the hollowness ratio is above 30%, the thickness of the crisscross portion of the cross section of fiber will be thinner and thus the fiber will be easily damaged in the subsequent weaving process. This will cause some problems, such as dyeing speck, and thus lower the quality.

The degree of variation of the cross section of the fiber of the present invention is between 2 to t 6, preferably, between 2.5 to 4.5. If the degree of variation of the cross section is below 2, the feeling of staying dry for the fabrics of the fiber is insufficient. If the degree of variation of the cross section is above 6, the producing process will get worse.

The Denier of the 4T cross section fiber of the present invention is between 0.8 to 15, preferably between 1 to 20, and more preferably, between 1 to 15.

The length of staple fibers made of the 4T cross section fiber of the present invention is between 22 mm to 100 mm, preferably between 38 mm to 90 mm.

The 4T cross section fiber of the present invention may be crimped in a spiral or zigzag shape.

The 4T cross section fiber of the present invention may be made of synthetic fibers, such as polyester, nylon and polypropylene.

The 4T cross section fiber of the present invention may be independently woven or mixed with other fibers, both of which can bring the dry and soft effects.

In accordance with another aspect of the invention, a spinneret for producing the fiber with 4T cross section as above-mentioned is provided. The spinneret comprises four T-shaped slits of spinning nozzles, each of which has a cap portion and a leg portion, each leg portion separating from each other.

In accordance with yet another aspect of the invention, a method for producing the fiber with 4T cross section as above-mentioned is provided. The method comprises the step of spinning fibers of polyester polymer in melting state through the spinneret as aforementioned, and then followed by the steps of quenching, drawing, thermosetting, cooling, wrinkling, oiling, drying, cotton-cutting, and packaging.

Therefore, the fiber with 4T cross section of the present invention can be easily produced by the above spinneret design and method.

The fabrics woven by the 4T cross section fiber of the present invention can has the outstanding effects of moisture absorption and sweat release as the above-mentioned. The effects can be further enhanced when processing together with a hydrophilic oil agent.

### BRIEF DESCRIPTION OF THE DRAWINGS

FIG. 1 schematically shows the cross section of one embodiment of the 4T cross section fiber of the present invention.

FIG. 2 is a photograph of the cross section of one embodiment of the 4T cross section fiber according to the present invention.

FIG. 3 schematically shows the arrangement of the cross section for several 4T cross section fibers of the present invention.

FIG. 4 schematically shows a crimped form of one embodiment of the 4T cross section fiber according to the present invention.

FIG. 5 schematically shows a diagram of a crimped form of another embodiment of the 4T cross section fiber according to the present invention.

FIG. 6 schematically shows the cross section of one embodiment of the spinneret of the present invention.

FIG. 7 schematically shows the cross section of another embodiment of the spinneret of the present invention.

FIG. 8 schematically shows the cross section of another embodiment of the spinneret of the present invention.

### DETAILED DESCRIPTION OF THE INVENTION

FIG. 1 shows the cross section of one embodiment of the 4T cross section fiber 10 of the present invention. The fiber includes four T-shaped lobes 11. Each of the T-shaped lobes 11 includes a cap portion 112 and a leg portion 111. Four leg portions 111 of the lobes 11 intersect at the center of the fiber 10. Each of the lobes 11 separates from each other. The adjacent T-shaped lobes 11 form an open hollow portion 12 severing as a guide channel to drain the moisture. The fiber 10 should also satisfy the following requirements:

0.8≦Deniers≦20

10°≦θ≦60°

10%≦Hollowness Ratio≦30%

Degree of Variation of the cross section(R/r)≦6

wherein θ represents the range of the hollow portion of the open hollow portion 12; R represents the radius of the circumcircle of the fiber 10; and r represents the radius of the incircle of the fiber 10.

In the embodiment of FIG. 1, the opening range of the hollow portion (θ) of the open hollow portion 12 is 15°; the radius of the circumcircle (R) is 8.2 μm; the radius of the incircle (r) is 2.1 μm; Denier is 3.0; and the degree of variation of the cross section (R/r) is 3.9.

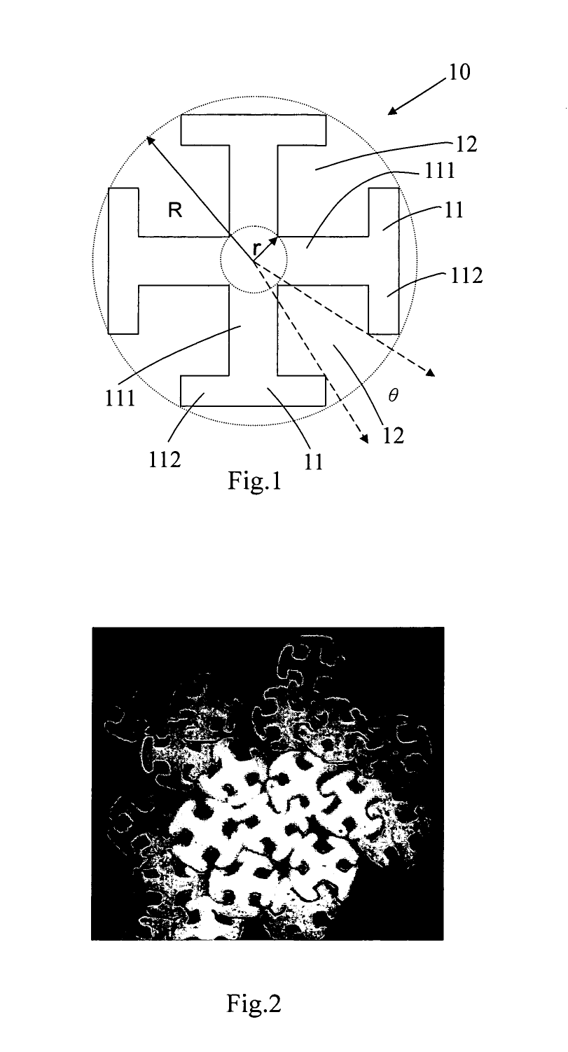

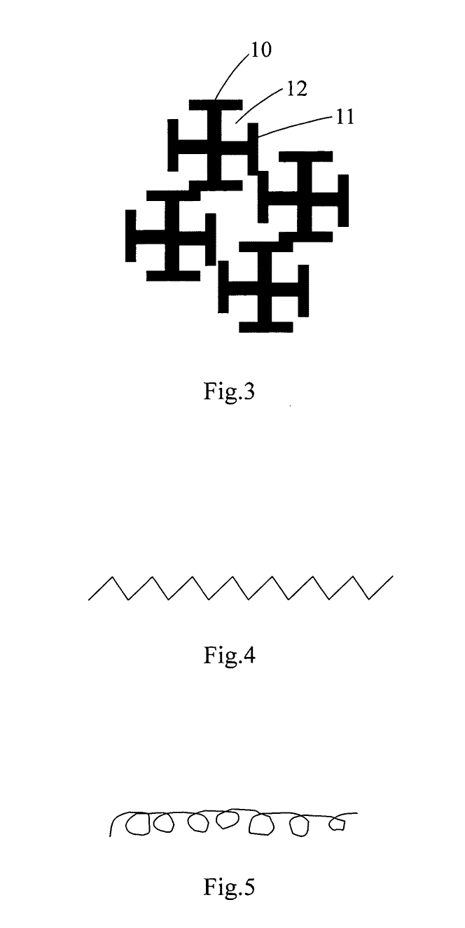

FIG. 2 is a photograph of the cross section of one embodiment of the 4T cross section fiber according to the present invention. Unlike the tight stack of conventional fibers, the fiber that satisfies the above requirements can preserve relatively large clearances. When several 4T cross section fibers 10 stack, as schematically shown in FIG. 3, by having the open hollow portions 12 act as guild channels, the fabrics woven by the fibers 10 absorb the moisture or sweat through these guide channels 12, thereby presenting outstanding water absorptivity for the fabrics. Also, when drying the fiber 10, the moisture or sweat is drained through the open hollow portions 12, thereby presenting an outstanding fast drying effect. Further, since the fiber 10 of 4T cross section has T-shaped lobes 11, the fabrics woven by the fibers 10 can preserve the clearances between the fibers 10 without tightly stacking. Therefore, the fabrics woven by the fiber have the capabilities of absorbing moisture and relieving sweat and the effect of keeping warm without having a muggy feeling.

FIG. 4 shows one embodiment of the 4T cross section fiber 10 according to the present invention, which is crimped into a 2D zigzag form. FIG. 5 shows another embodiment of the 4T cross section fiber 10 according to the present invention, which is crimped into a 3D spiral form. Of course, the fiber of the 4T cross section of the present invention can also be crimped into other crimp forms.

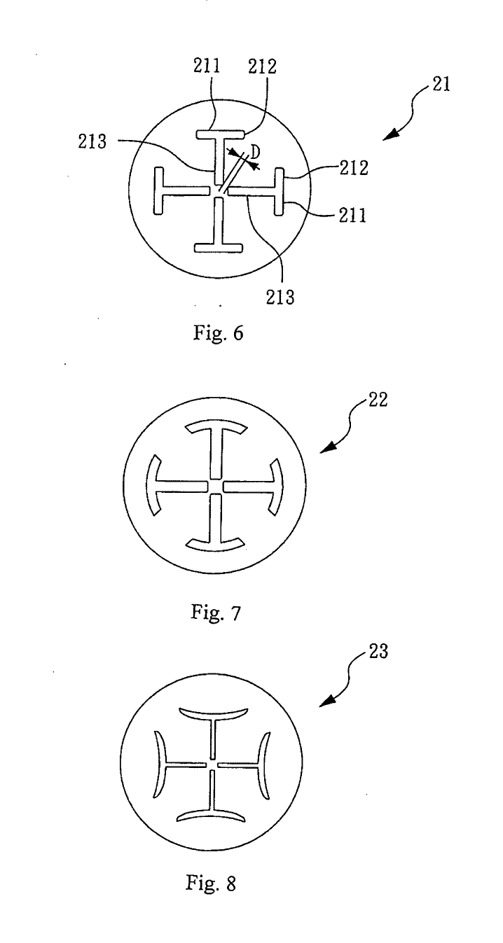

FIG. 6 shows the cross section of one embodiment of the spinneret 21 that produces the fiber 10 of the 4T cross section of FIG. 1 of the present invention. The spinneret 21 includes four T-shaped slits of spinning nozzles 211. Each of the T-shaped slits of spinning nozzles 211 has a straight line-shaped cap portion 212 and a leg portion 213. The ends of leg portions 213 of the slits of spinning nozzles 211 separate from each other.

Generally, the width of cap portion 212 is between 0.05 mm to 0.09 mm, and the length of cap portion 212 is between 0.30 mm to 0.60 mm. The width of the leg 213 is between 0.03 mm to 0.08 mm, and the length of the leg 213 is between 0.50 mm to 0.80 mm. The distance (D) of the ends of the adjacent legs 213 is between 0.02 mm to 0.05 mm.

The legs 213 of the four T-shaped slit of spinning nozzles 211 are not connected at their ends. The fiber 10 with 4T cross section as shown in FIG. 1 is obtained by the expansion of the polymer extruded from the legs 213 which causes the legs 111 of the fiber 10 to connect to each other. In comparison with the conventional technique that the legs of the T-shaped slits of spinning nozzles are connected to each other (e.g., U.S. Pat. No. 5,057,368), after a long-term spinning, the ends of the legs 213 of the T-shaped slits of spinning nozzles 211 will not wear out, therefore facilitating the spinning operation and maintaining the integrality for the cross section of the fiber. Also, it is easy to manage the spinneret.

The polymer (such as polyester) in melting form is extruded through the T-shaped slits of spinning nozzles 211 of the above-mentioned spinneret 21. After quenching, drawing, thermosetting, cooling, wrinkling, oiling, drying, cotton-cutting and packaging, the fiber 10 with 4T cross section as shown in FIG. 1 is obtained.

FIG. 7 and FIG. 8 show spinnerets (22, 23) of the present invention in different form. The spinnerets for producing the fiber with 4T cross section of the present invention can be slightly changed in shape, such as changing the cap of the T-shaped slit of spinning nozzle into concave shape or convex shape rather than straight-line shape. These changes can also achieve the above-mentioned effects.

The physical properties of the products produced in the embodiment of the present invention and the comparative example can be determined and evaluated in accordance with the following methods:

### 1. Test for the Fineness of Fibers: (CNS 13756 Test Method for Fiber Fineness)

Comb several fiber samples in parallel with a metal comb and place them on a cutting table. Press them with a plate gage while the samples are drawn straightly by proper tension. Cut the samples at the length of 30 mm. Count 300 fibers to form one set of samples (If the fiber is shorter than 30 mm, just make the total length of the chosen fibers to be 9000 mm). Measure the mass of the set of samples so as to obtain the measure of fiber Denier (d′). Obtain the standard fiber Denier (d) by using equilibrium moisture regain from the following equation. Test five times and calculate the average to the first decimal place.

Standard fiber Denier

$$( d ) = {d}^{′} \times \frac{100 + Rc}{100 + Re}$$

wherein
d′ represents the measure of fiber Denier,
Rc represents the nominal moisture regain (%),
Re represents the equilibrium moisture regain (%).

### 2. Test for the Hollowness Ratio

The cross section of a monofilament is magnified 400 times by using an optical microscope to measure the average ratio between the total areas of the hollow portions and the total areas of the cross sections for 20 monofilaments

### 3. Test for the Degree of Variation of the Cross Section

The cross section of a monofilament is magnified 400 times to measure the radius of the circumcircle of the fiber (R) and the radius of the incircle of the fiber (r). Then the degree of variation of the cross section is calculated according to the following equation:

Degree of Variation of the cross section=R/r

### 4. Test for the Water Content Per Gram for Cotton

Take 5 grams (G1) of sample and put it into a vessel with filter. After fully soaking the sample in water for 10 minutes, hang the sample freely until no water drip. Then weight the sample (G2). The water content per gram for cotton is then obtained according to the following equation:

The water content per gram for cotton=(G2−G1)/G1

### Example 1

The polyester polymer in melting form is extruded through a spinneret as shown in FIG. 6 and then the filaments are quenched by cooling air at a rate of 40 nm/hr, and the filaments are formed at a spinning rate of 700 m/min. After the yarns are drawn at a total elongation of 2.89, these yarns are subject to 160° C. thermosetting, cooling, wrinkling, oiling, drying, cutting, and packaging steps. The 4T cross section fibers of 3D×51 mm thus can be obtained. The properties of the fiber are listed in the following Tables 1 and 2.

### Comparative Example 1

In accordance with the same procedures of Example 1, a conventional round-shaped cross section spinneret is used to extrude the melted polyester polymer and then a round-shaped cross section fiber of 3D×51 mm can be obtained. The properties of said fiber are listed in the following Tables 1 and 2.

TABLE 1
Properties of the 4T cross section fiber of the present invention
and the round-shaped cross section fiber of the prior art

| | Example 1 | Comparative Example 1 |
|---|---|---|
| | 3D * 51 mm | 3D * 51 mm |
| Items | 4T cross section | round-shaped cross section |
| Length (mm) | 52.4 | 51.00 |
| Fineness (De) | 3.0 | 3.04 |
| Strength (g/d) | 3.96 | 5.37 |
| Elongation (%) | 40.8 | 48.6 |
| Crimp Numbers | 11.4 | 11.48 |
| (25 mm) | | |
| Crimp Stability (%) | 68.6 | 67.94 |
| Degree of Variation of | 3.9 | 1 |
| the cross section (R/r) | | |
| Hollowness Ratio (%) | 25 | 0 |
| θ | 30 | 0 |
| TE-10 (g/D) | 2.3 | 2.60 |

TABLE 2
Comparative Data of the Water Absorption for the fabrics woven
by the 4T cross section fiber of Example 1 and the fabrics woven
by the round-shaped cross section fiber of Comparative Example 1.

| | | Cotton | | Water | |
|---|---|---|---|---|---|
| | | plus | | content per | Average |
| | Cotton | Water | | gram for | Water |
| | Weight | Weight | Water | cotton (g) | Absorption |
| | (G1) | (G2) | Weight | (G2 − G1)/G1 | (g) |
| Fabrics | 5.42 | 83.34 | 77.92 | 14.38 | 13.67 |
| (cotton) of | 5.67 | 79.21 | 73.54 | 12.97 | |
| Example 1 | | | | | |
| Fabrics | 5.5 | 48.05 | 42.55 | 7.74 | 7.92 |
| (cotton) of | 5.62 | 51.16 | 45.54 | 8.10 | |
| Comparative | | | | | |
| Example 1 | | | | | |

From Table 1 and 2, it is known that the 4T cross section fiber of the present invention has better physical properties and water absorptivity than the conventional round-shaped cross section fiber.

What is claimed is:

1. A fiber with 4T cross section, comprising four T-shaped lobes, each of said T-shaped lobes having a cap portion and a leg portion, each of the leg portions of said lobes intersecting at the center of the fiber, each of said lobes separating from each other, and the adjacent T-shaped lobes forming an open hollow portion, wherein the fiber fulfills the following requirements:
0.8≦Denier≦20
10°≦θ≦60°
10%≦Hollowness Ratio≦30%
2≦Degree of Variation of the cross section(R/r)≦6
wherein θ represents the range of the hollow portion, R represents the radius of the circumcircle of the fiber, and r represents the radius of the incircle of the fiber.

2. The fiber as claimed in claim 1, wherein the hollowness ratio is between 15% to 30%.

3. The fiber as claimed in claim 2, wherein the hollowness ratio is between 15% to 25%.

4. The fiber as claimed in claim 1, wherein the degree of variation of the cross section is between 2 to 5.

5. The fiber as claimed in claim 4, wherein the degree of variation of the cross section is between 2.5 to 4.5.

6. The fiber as claimed in claim 1, wherein the opening range of the hollow portion is between 15° to 45°.

7. The fiber as claimed in claim 1, wherein the fiber is a polyester fiber structure.

8. A spinneret for producing the fiber with 4T cross section as claimed in claim 1, comprising four T-shaped slits of spinning nozzles, each of said T-shaped slits of spinning nozzles having a cap portion and a leg portion, each leg portion of said slits of spinning nozzles separating from each other than connecting to each other.

9. A method for producing the fiber with 4T cross section as claimed in claim 1, comprising a step of extruding the polyester polymer in melting form through a spinneret comprising four T-shaped slits of spinning nozzles, each of said T-shaped slits of spinning nozzles having a cap portion and a leg portion, each leg portion of said slits of spinning nozzles separating from each other than connecting to each other.
